(19) United States
(12) Patent Application Publication
(10) Pub. No.: US 2017/0032036 A1
(43) Pub. Date: Feb. 2, 2017

(54) System and Method for Model Creation in an Organizational Environment

(71) Applicant: Interactive Intelligence Group, Inc., Indianapolis, IN (US)

(72) Inventors: Jon W. McCain, Indianapolis, IN (US); Michael Z. Jones, Bolingbrook, IL (US); Kevin D. Small, Zionsville, IN (US)

(73) Assignee: Interactive Intelligence Group, Inc.

(21) Appl. No.: 14/814,543

(22) Filed: Jul. 31, 2015

(51) Int. Cl. G06F 17/30; G06N 5/04; G06N 99/00

(52) U.S. Cl. CPC G06F 17/30864; G06N 99/005; G06N 5/04

(57) ABSTRACT

A system and method are presented for the assessment of skills in an organizational environment. Intelligent processing of information presented through various types of media is performed to provide users with more accurate matches of desired information. Relevant information may be obtained based on keyword searches over various media types. This information is cleaned for model creation activities to provide the desired information to a user regarding skill sets. Desired information may comprise data regarding the frequency of keywords in relation to the keyword search and how these keywords pertain to skills and other requirements. Models are constructed from the information, which are then analytically used for various purposes in the organizational environment.

### BACKGROUND

The present invention generally relates to telecommunications systems and methods, as well as model creation for organizational environments. More particularly, the present invention pertains to the intelligent processing of the information used for machine learning purposes.

### SUMMARY

A system and method are presented for the assessment of skills in an organizational environment. Intelligent processing of information presented through various types of media is performed to provide users with more accurate matches of desired information. Relevant information may be obtained based on keyword searches over various media types. This information is cleaned for model creation activities to provide the desired information to a user regarding skill sets. Desired information may comprise data regarding the frequency of keywords in relation to the keyword search and how these keywords pertain to skills and other requirements. Models are constructed from the information, which are then analytically used for various purposes in the organizational environment.

In one embodiment, a method is presented for processing raw information in a plurality of profiles, based on search criteria, for model creation in a system comprising a database operatively coupled to at least an automatic indexer, a data processor, a data analyzer, and an engine, the method comprising: retrieving the raw information, by the automatic indexer from web pages, from a plurality of profiles contained in the web pages and storing the raw information in the database; retrieving the raw information from the database and processing, by the data processor, the raw information into a format for storage in the database; storing, by the data processor, the processed information in the database; executing, by the automatic indexer, a query and loading all processed information related to the query; processing, by the data analyzer, the processed information in the database to determine statistical information, wherein said statistical information is associated with individual profiles from the plurality of profiles; and creating, by the engine, models from the processed information in the database.

In another embodiment, a method is presented for processing raw information in a plurality of profiles, based on search criteria, for updating models in a system comprising a database operatively coupled to at least an automatic indexer, a data processor, a data analyzer, and an engine, the method comprising: retrieving the raw information, by the automatic indexer from web pages, from a plurality of profiles contained in the web pages and storing the raw information in the database; retrieving the raw information from the database and processing, by the data processor, the raw information into a format for storage in the database; storing, by the data processor, the processed information in the database; executing, by the automatic indexer, a query and loading all processed information related to the query; processing, by the data analyzer, the processed information in the database to determine statistical information, wherein said statistical information is associated with individual profiles from the plurality of profiles; and updating, by the engine, models from the processed information in the database and storing the models for later use.

In another embodiment, a system is presented for processing raw information in a plurality of profiles for model creation comprising: a means capable of retrieving information from a plurality of profiles based on searches of one or more of: keywords, skill sets, job types, and job titles; a means which cleans the retrieved information and is operatively coupled to the means capable of retrieving information; and a means which processes the clean information to create the model and is operatively coupled to the means which cleans.

### BRIEF DESCRIPTION OF THE DRAWINGS

FIG. 1 is a diagram illustrating a high level embodiment of a system for model creation.

FIG. 2 is an embodiment of a sequence diagram for information searching.

FIG. 3 is a diagram illustrating an embodiment of a process for creating a model.

FIG. 4 is a diagram illustrating an embodiment of a process for creating a profile.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

In today's job market, applicants and employers are increasingly moving from paper resumes and Curriculum Vitaes (CV) into electronic resumes and CVs. Websites, such as monster.com and careerbuilder.com, specialize in connecting organizations searching for potential employees with persons searching for jobs matching their skill sets. These websites become clearing houses, in essence, for the types of jobs various segments of the economy are demanding. The embodiments described herein exist to provide users with statistics-based information on keywords found within job descriptions and the assessment of skills, such as how these keywords pertain to the skills and requirements for individual jobs.

The skills assessment of postings for jobs on job-specific websites may be based on search criteria. The assessment aids recruiters and hiring managers in finding candidates and filling positions with respect to skills required to accomplish a job. Candidates may also be aided in finding better matches for job openings than through a simple keyword search of open positions. A “job” may refer to the concept of “job title” or a specific set of responsibilities that are commonly associated with a particular job title, a specific job posting, or a set of search results generated by searching for a specific job title or a set of related job titles. The job posting might be presented as an advertisement through various media (job sites, newspapers, magazines, word of mouth, etc.) that seeks to find someone to carry out the responsibilities of the job within a specific organization. The job-specific website might comprise a website that specializes in connecting organizations that want to post a job description with those who are looking to find a job that matches their skill sets. The websites may also contain types of jobs that various segments of the economy want filled, such as field specific sites.

Multimedia based resumes can link to common interview questions, provide assessment scores related to soft/hard skills, and comprehensive project histories that expand beyond limited versions of information contained in a curriculum vitae or resume. The embodiments described herein aid candidates, recruiters, and hiring managers, among others, in viewing skills that are common to a particular position they are looking to apply to, search, or fill, respectively.

Users are provided with information on keywords found within job descriptions and how those keywords pertain to the skills requirements for individual jobs. In an embodiment, this information on keywords is statistic-based. An engine is tasked with seeking out job postings on various websites across the internet using predefined search criteria. Once the search has occurred, text is automatically pulled from those job postings, prepared for analysis, and the results analyzed. The analysis may be based on data mining techniques and machine learning. Models are constructed using the analysis of information in order to provide statistical information regarding the skills associated with individual jobs. The engine is able to provide those interested in certain careers with information on common skills required for such positions by performing a statistics-based representation of a job using the unique combination of words found associated with a particular job, or what may also be referred to herein as a JobPrint. Examples of provided information may include resume analysis, job description analysis, geo-location of potential employers based on job descriptions (e.g., groupings of particular openings for particular fields in particular areas).

A JobPrint may comprise a model based upon statistical information that can be used to compare other jobs or CVs and resumes in order to determine if that job, CV, or resume, matches the model within the system. The JobPrint can be used to provide feedback on a potential candidate's CV or resume, vetting newly written job descriptions by hiring managers and recruiters, and integrated into product suites for skills-based tagging, such as Interactive Intelligence Group, Inc.'s PureCloud™ Collaborate or PureCloud™ Engage. Profiles of job sites can be created to handle specific search steps unique to each job posting website, such as careerbuilder.com, monster.com, indeed.com, etc., and utilize expressions for retrieving specific pieces of information from each job description pulled from the accessed site. An example of a profile of a job site may contain information relating to search variations, such as the desired keywords (e.g. “Software Engineer”), the desired category (e.g., job types), and Locations (e.g., Indianapolis). The job site profiles may also contain a set of properties outlining how to access, search, and parse a particular job posting site.

Audit trails for the originally retrieved data and the data normalization process are also provided. The audit trails may comprise the history of a particular job within the system such as the original job postings, the job site that they were found on, the date the job postings were downloaded, and when the job postings were processed. Data is cleaned to remove items such as HTML involved in displaying links to other parts of the job page, advertisements, dynamic scripts, etc. The clean data is then stored to be used for data mining and machine learning for the statistical models in the skills engine.

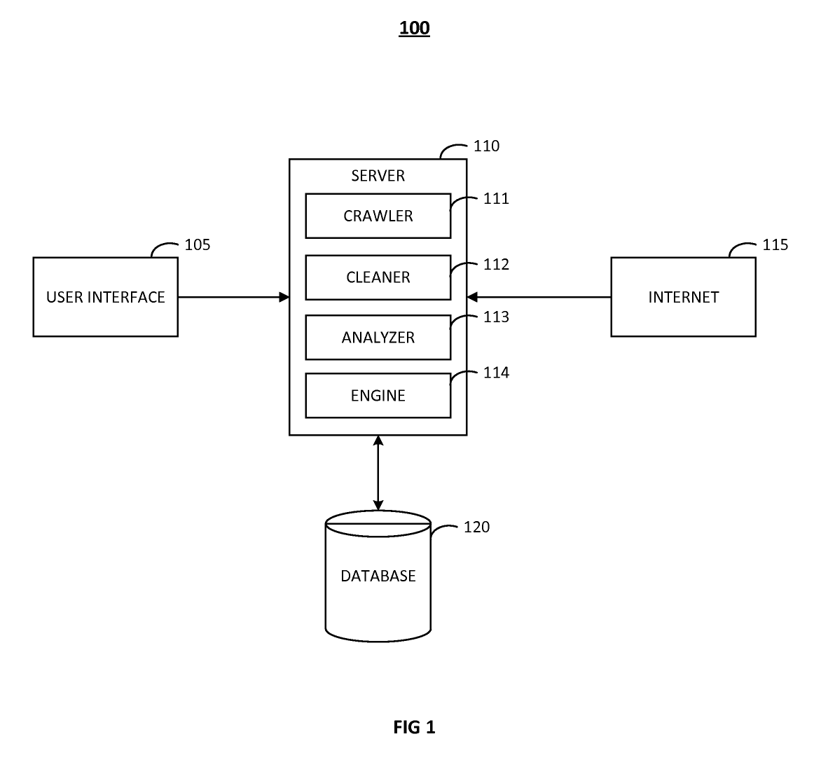

FIG. 1 illustrates a high level embodiment of a system for model creation, indicated generally at 100. The components of the model creation system 100 may include: a user interface 105; a server 110 which comprises a crawler 111, a cleaner 112, an analyzer 113, an engine 114; a network 115, and a database 120.

A user interface 105 is used to provide relevant information through a computer to the server 110. The user interface 105 may provide incoming requests from various users that the system executes. The user interface 105 is capable of providing a mechanism to view already-processed JobPrints, request new JobPrints for creation based on specific search terms, and view results of the analysis, among other functions. The server 110 may comprise at least a crawler 111, a cleaner 112, an analyzer 113, and an engine 114. The crawler 111 may retrieve job description information using job site profiles based upon keyword and job type searches. The cleaner 112 may process raw text data from the crawler 111 into formats for data mining and machine learning activities. The analyzer 113 may provide statistical information, such as models, regarding hard and soft skills in relation to frequency of words found by job title.

The engine 114 may comprise a skills engine, which utilizes the model created by the other components within the server 110. An engine 114 is tasked with seeking out job postings on various websites across the internet using predefined search criteria. Once the search has occurred, text is automatically pulled from those job postings, prepared for analysis, and the results analyzed. The analysis may be based on data mining techniques and machine learning. The analysis may be used to provide statistical information using a model constructed from the pulled information, regarding the skills associated with individual jobs. The engine is then able to provide those interested in certain careers with information on common skills required for such positions by performing a statistics-based representation of a job using the unique combination of words found associated with a particular job.

The crawler 111, cleaner 112, analyzer 113, and engine 114, interact via the server 110 over a network with the internet websites 115 and provide the information to be stored in a database 120. The database 120 may comprise storage for data that is raw, has been cleaned, and has been processed.

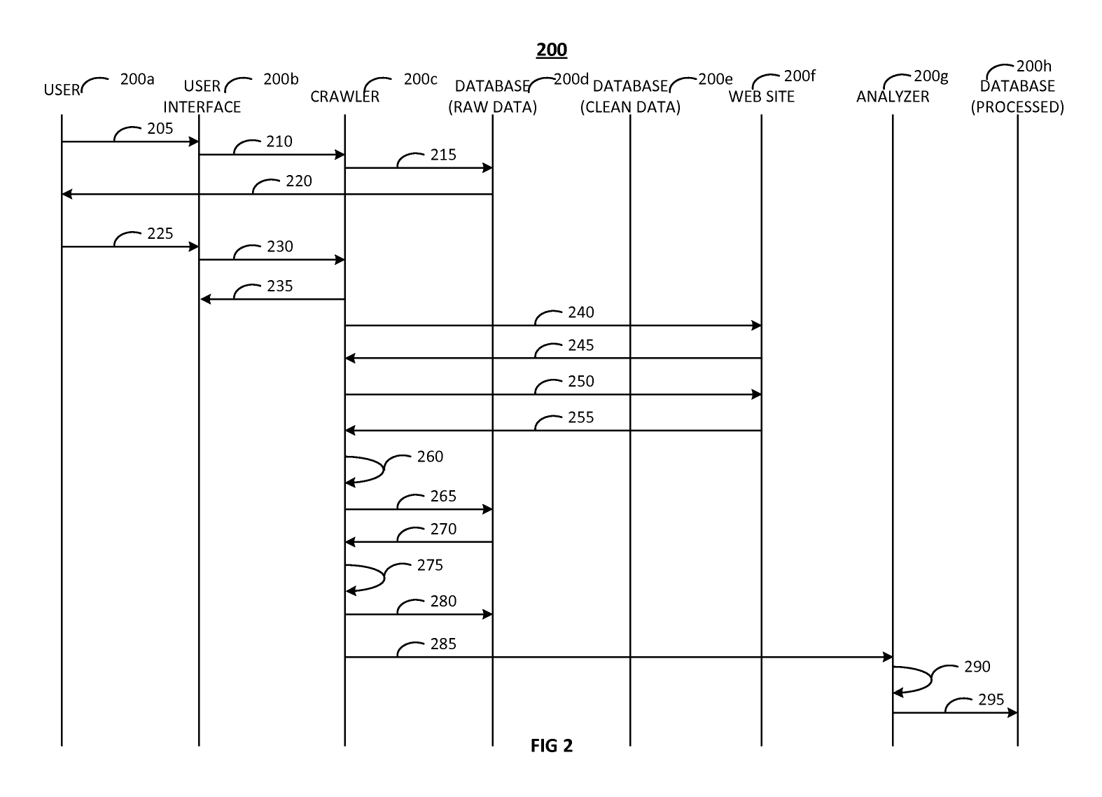

FIG. 2 illustrates an embodiment of a sequence diagram for information searching, indicated generally at 200, which may occur within the engine described in FIG. 1. In an embodiment, the sequence diagram may apply to the skills engine searching jobs across job websites.

The User 200a loads the skills engine web interface 205 into the User Interface 200b. A request is made to the server to load available job profiles 210, such as available JobPrints that have been previously created. The request may be made through the user interface. The request 210 may also contain a request for recent search results as well from the web crawler 200c. The request is made to a database 200d containing raw data of available job profiles and searches 215. The job profiles and search options are returned 225 to the user 200a. The user is then able to select job profiles that meet their criteria as well as determine what sort of searches they want to execute 225. The search execution 230 is performed and the UI search status is updated to pending 235.

In an example, the user, Blake, may be a potential job candidate who is trying to understand job descriptions and is overwhelmed by all of the information available. He needs guidance on what he is looking for in a position. He can search for specific job titles or use keywords as well as pull JobPrints that help him read, understand, and apply for job postings.

In another example, the user may comprise a recruiter, Stephanie, who is pressed for time, under pressure to deliver quality candidates, and needs to effectively translate the business needs of an employer into accurate job descriptions. She may pull JobPrints that help with hiring, coaching candidates, as well as information to help her work more effectively with hiring managers. In yet another example, a hiring manager may be able to use the JobPrints to help work with recruiters.

The crawler 200c executes the search 240 from the job posting sites 200f. A list of job Uniform Resource Identifiers (URIs) is returned to the crawler 200c. The crawler 200c initiates a multi-threaded retrieval of URI content from the site, which is returned to the crawler. The crawler 200c breaks down the retrieved content into artifacts 260. An artifact may comprise the raw contents of a job posting and items related to this job posting as described by the profile of the jobsite. These artifacts are committed 265 to the raw database 200d.

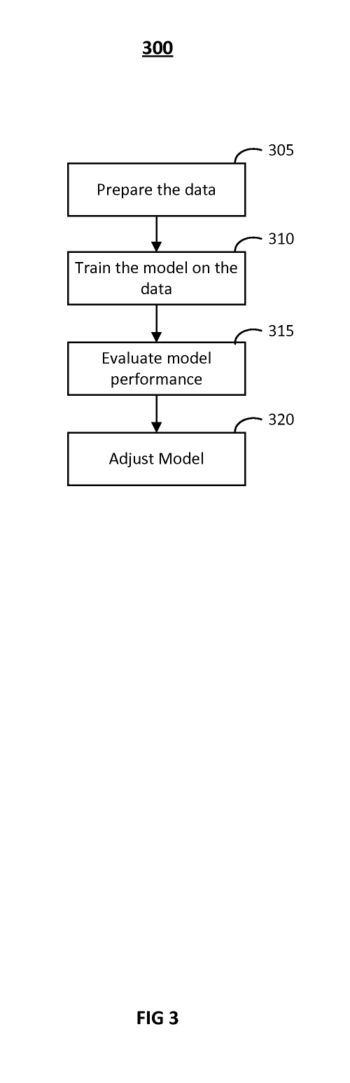

The raw database 200d notifies the crawler 200c of individual jobs that may be available 270 which meet the search criteria. It should be noted that steps 250 through 270 may be run in a continuous loop, constantly providing updates. This raw job data 275 is transformed into clean data by the cleaner and stored 280 in the database as clean data 200e. Profiles of jobsites may contain rules with how to remove boilerplate information from a given posting. For example, the HTML involved in displaying links to other parts of the job page, product advertisements, dynamic scripts, etc., may be removed to ease processing. Data cleanup may be adjusted based on the sites either manually or automatically based on whether a specific cleanup step is beneficial for the statistical model or not. Frequency filtering may also be used to look for special relationships, such as the number of years of experience required for a posting. The results of the clean-data related to the specific search are picked up by the analyzer for later use in the statistical model. The search status is then updated as complete 285. It should be noted that steps 270 through 285 can also be run in a continuous loop. The clean data is then pulled by the analyzer 200f to create the model 290, which is further discussed below in FIG. 3. The data is then stored 200g in the database 295.

FIG. 3 is a diagram illustrating an embodiment of a process 300 for creating a model. The created model may be used to suggest matching job titles based upon user provided resumes or CVs or job descriptions.

In operation 305, data is prepared. For example, the data is examined and a corpus is built by mining data. The corpus is cleaned to remove unnecessary data, such as stop-words, punctuation, whitespace, etc. The clean corpus is examined and the training and test datasets are created. Control is passed to operation 310 and the process 300 continues.

In operation 310, the model is trained on the datasets. For example, the model may be trained using textual data from a large corpus of job descriptions containing known information such as job title, company, and location. The large corpus may contain thousands of job descriptions. Control is passed to operation 315 and the process 300 continues.

In operation 315, the model performance is evaluated. For example, updates to the model may be made when new information is available by performing additional queries. Feedback loops may also be utilized. Predictions may be marked as inaccurate through feedback loops with users of the system. Certain responses may be weighted to provide more accurate responses in subsequent encounters by the engine with similar datasets. Control is passed to operation 320 and the process 300 continues.

In operation 320, adjustments may be made to improve the performance of the model. This step may be optional, depending on the needs of the user.

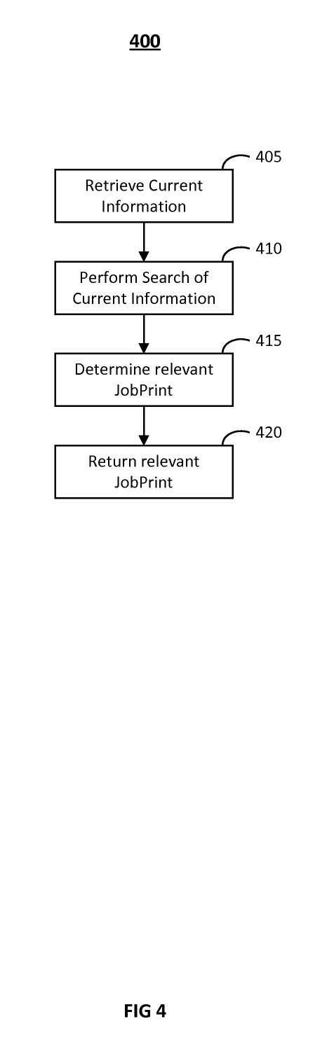

FIG. 4 a diagram illustrating an embodiment of a process 400 for creating a profile using the model generated in the process 300. The profile may comprise a JobPrint, as previously described, or any other profile of a model based on statistical information that can be used to compare other jobs or resumes in order to determine if that job or resume matches the model.

In operation 405, current information is retrieved from the database. The user interface may indicate to the database that the latest relevant job titles are desired, upon which a user may indicate through the user interface which job title they want to search for. Control is passed to operation 410 and process 400 continues.

In operation 410, a search is performed of the current information within the database. The search results may then be aggregated into a single result, with that single result stored in the database for later retrieval. Optionally, intermediate results may be stored in order to provide updates to the aggregate more efficiently at a later time. Control is passed to operation 415 and the process 400 continues.

In operation 415, relevant JobPrints are determined. For example, certain unique word sets occur at specific frequencies for specific jobs or job categories. Clustering may be used to associated the words that allows the formation of groups based on their relation to one another (ie., a Software Engineer will share certain skills with a Mechanical Engineer). Once the clusters have been defined using a dataset where the textual data is associated with known job titles, textual data for unknown job titles can be provided to the clusters with predictions for what those jobs may be. Control is passed to operation 420 and process 400 continues.

In operation 420, the relevant JobPrint is returned to the user and the process 400 ends.

Various embodiments may exist utilizing the skills engine as previous described. In one example, the skills engine may be used for various activities, such as searching for jobs, viewing/rendering original job postings from sites, creating or updating job site profiles, JobPrints, geo-location analytics, and other trends in technology.

In another embodiment, the skills engine obtains raw data from job postings across the internet and feeds that data into a database. The database data is then used for data mining and model generation by the skills engine.

In another embodiment, the skills engine views/renders original job postings from job posting sites. For the purpose of content verification, the skills engine has the ability to re-render or view the original website in which the data was originally retrieved.

In yet another embodiment, the skills engine can create or update job site profiles. New job site profiles may be created for particular job posting sites as well as programmatically search the page using headless browsers and other methods. Profiles of jobsites may be made due to changing web site format and layout. Periodic re-checks may be performed of entries in the raw-data database. New information may be retained and the cleaner removes old information. The analyzer may then update the relevant models with the new data in place of the old. Updates may also be made at any time a new JobPrint is being created that includes a posting already downloaded for another JobPrint.

In another embodiment, the skills engine can create statistical models for job titles based on frequency of associated words with a title. The statistical model can also be updated for a job title by performing additional queries for that title/field and adding that data into the database. JobPrints can also be viewed by job title and rendered in many forms as it is a set of constrained frequencies of words. Windows into the types of skills or technologies necessary for a position/field may be provided. Further, JobPrints may be viewed by category as well as job description. Viewing job prints based upon a provided job description assists in the composition of job descriptions to better fit a position needed. Matching JobPrints may be based upon provided resumes or CVs. A provided resume may be processed to determine which JobPrint(s) is the best match. Candidates may be assisted in determining whether a resume is demonstrating necessary skills for a position, i.e., whether the resume was written to showcase the talents or skills required by a position.

In another embodiment, geo-location analytics may be used to view geo-locations of individuals seeking jobs and the geo-location of the companies hiring. Using the address information for users of the system (from JobPrints, resume processing, job description vetting, etc.) maps can be compiled with details of where candidates live. This information may also be helpful for future office location planning initiatives, among other purposes. The geo-location of hiring companies may be used to determine budding areas of new technology.

In yet another embodiment, trends in technology may be viewed by analyzing the increases in frequency for certain hard skillsets. This provides hiring companies with an edge to determine areas where trends are popping up and starting initiatives in these areas before competitors in order to capture the best and brightest potential hires.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A method for processing raw information in a plurality of profiles, based on search criteria, for model creation in a system comprising a database operatively coupled to at least an automatic indexer, a data processor, a data analyzer, and an engine, the method comprising:
a. retrieving the raw information, by the automatic indexer from web pages, from a plurality of profiles contained in the web pages and storing the raw information in the database;
b. retrieving the raw information from the database and processing, by the data processor, the raw information into a format for storage in the database;
c. storing, by the data processor, the processed information in the database;
d. executing, by the automatic indexer, a query and loading all processed information related to the query;
e. processing, by the data analyzer, the processed information in the database to determine statistical information, wherein said statistical information is associated with individual profiles from the plurality of profiles; and
f. creating, by the engine, models from the processed information in the database.

2. The method of claim 1, wherein the raw information comprises job description information from profiles of job sites.

3. The method of claim 1, wherein the retrieving is performed based on searches comprising one or more of: keywords, job titles, search strings, category, and location.

4. The method of claim 1, wherein the statistical information comprises at least one of hard skills in relation to frequency of words found in profiles and soft skills in relation to frequency of words found in profiles.

5. The method of claim 1, wherein processing further comprises rendering original job postings from job posting sites for content verification.

6. The method of claim 1, wherein processing further comprises creating profiles of the job site.

7. The method of claim 6, wherein the created profiles of the job sites are targeted for particular posting job sites.

8. The method of claim 1, wherein processing further comprises managing updates to profiles of job sites.

9. The method of claim 1, wherein the models are generated by one or more of: job title, job category, and job description.

10. The method of claim 1, wherein the model is generated based upon provided resumes.

11. The method of claim 1, wherein the processing is based upon geolocation analytics.

12. The method of claim 11, wherein the geolocation analytics comprise locations of individuals seeking jobs.

13. The method of claim 12, wherein the geolocation analytics comprise locations of companies seeking individuals.

14. The method of claim 1, wherein the processing is based upon trending technologies.

15. The method of claim 1, wherein the automatic indexer comprises a web crawler.

16. The method of claim 1, wherein the automatic indexer comprises a human designated data operation from a specific designated web-url.

17. A method for processing raw information in a plurality of profiles, based on search criteria, for updating models in a system comprising a database operatively coupled to at least an automatic indexer, a data processor, a data analyzer, and an engine, the method comprising:
a. retrieving the raw information, by the automatic indexer from web pages, from a plurality of profiles contained in the web pages and storing the raw information in the database;
b. retrieving the raw information from the database and processing, by the data processor, the raw information into a format for storage in the database;
c. storing, by the data processor, the processed information in the database;
d. executing, by the automatic indexer, a query and loading all processed information related to the query;
e. processing, by the data analyzer, the processed information in the database to determine statistical information, wherein said statistical information is associated with individual profiles from the plurality of profiles; and
f. updating, by the engine, models from the processed information in the database and storing the models for later use.

18. The method of claim 17, wherein the raw information comprises job description information from profiles of job sites.

19. The method of claim 17, wherein the retrieving is performed based on searches comprising one or more of: keywords, job titles, search strings, category, and location.

20. The method of claim 17, wherein the statistical information comprises at least one of hard skills in relation to frequency of words found in profiles and soft skills in relation to frequency of words found in profiles.

21. The method of claim 17, wherein processing further comprises rendering original job postings from job posting sites for content verification.

22. The method of claim 17, wherein processing further comprises creating profiles of the job site.

23. The method of claim 22, wherein the created profiles of the job sites are targeted for particular posting job sites.

24. The method of claim 17, wherein processing further comprises managing updates to profiles of job sites.

25. The method of claim 17, wherein the models have been generated by one or more of: job title, job category, and job description.

26. The method of claim 17, wherein the model has been generated based upon provided resumes.

27. The method of claim 17, wherein the processing is based upon geolocation analytics.

28. The method of claim 27, wherein the geolocation analytics comprise locations of individuals seeking jobs.

29. The method of claim 27, wherein the geolocation analytics comprise locations of companies seeking individuals.

30. The method of claim 17, wherein the processing is based upon trending technologies.

31. The method of claim 17, wherein the automatic indexer comprises a web crawler.

32. The method of claim 17, wherein the automatic indexer comprises a human designated data operation from a specific designated web-url.

33. A system for processing raw information in a plurality of profiles for model creation comprising:
a. a means capable of retrieving information from a plurality of profiles based on searches of one or more of: keywords, skill sets, job types, and job titles;
b. a means which cleans the retrieved information and is operatively coupled to the means capable of retrieving information; and
c. a means which processes the clean information to create the model and is operatively coupled to the means which cleans.

34. The system of claim 33, wherein the means capable of retrieving information comprises a web crawler.

35. The system of claim 33, wherein the model comprises statistical information on one or more of: keywords, job titles, search strings, category, and location.

36. The system of claim 33, wherein the means which processes comprises an analyzer.

37. The system of claim 33 further comprising an engine, wherein the skills engine is capable of providing statistical information regarding skills associated with a particular profile.
